(19) United States
(12) Patent Application Publication
(10) Pub. No.: US 2004/0166309 A1
(43) Pub. Date: Aug. 26, 2004

(54) Reactivatable adhesive

(76) Inventors: Lie-Zhong Gong, Bridgewater, NJ (US); Justin A. Mehaffy, Hampton, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/371,668

(22) Filed: Feb. 22, 2003

(51) Int. Cl. B32B 7/12

(52) U.S. Cl. 428/343

(57) ABSTRACT

An adhesive capable of reactivating upon exposure to radiant energy. The adhesive is pre-applied to a substrate and, when ready to use, reactivated upon exposure to short durations of radiant energy.

### FIELD OF THE INVENTION

The invention relates to adhesives. More specifically, the invention is directed to reactivatable adhesives, substrates comprising a reactivatable adhesive and articles of manufacture comprising a substrate having applied on a surface thereof a reactivatable adhesive.

### BACKGROUND OF THE INVENTION

Adhesives are widely used for various commercial applications. Hot melt adhesives, for example, are commonly used in product assembly and packaging applications, including cardboard case sealing and carton closing operations. Such hot melt adhesives are applied to a substrate while in its molten state and cooled to harden the adhesive layer.

In the conventional case and carton packaging process for food and consumer applications, the boxes are first filled with food or consumer goods, then a hot melt adhesive is applied to the flap of boxes on the packaging line and compression is exerted to seal the boxes. While this process works reasonably well, it requires the packaging company to devote a tremendous amount of time and attention to adhesive-related issues, including adhesive selection, processing, trouble shooting, inventory, and maintenance of adhesive application equipment. First, selection of an adhesive having the required adhesion, setting speed, and open time is a lengthy process. Then the adhesive needs to be processed in an appropriate way such as melting, transporting, and applying. If anything is wrong with the processing, the boxes will not seal properly, the packaging line must be stopped, and the problem identified and fixed.

Heat sealing of pre-applied adhesives is known and practiced in the art. Heat sealed closures and seams are commonly used in the manufacture of bags, whereby adhesive is coated on the inside of the bag seam and subsequently sandwiched under intense heat and pressure using heated platens or bars. This direct application of heat and pressure renders the adhesive molten, after which a bond is formed. This application benefits from the ability to apply steady direct pressure to ensure intimate contact and sufficient wetting of the adhesive layer to the substrate. This process cannot be used for applications where high pressure for closing is not available, such as in case and carton packaging processes. While focused hot air has been used to reactive pre-applied adhesives used in case and carton sealing operations, this method requires extremely large amounts of energy and can result in undesired heating of the substrate or package, its contents, and the surrounding area and equipment. Moreover, line speed is slow

A need exists in the art for reactivatable adhesives that can advantageously be applied to a substrate and later (e.g., during manufacture of the finished product), reactivated to adhere the substrate to a second substrate, whereby application of adhesive in the manufacturing or packaging line is avoided. The current invention addresses this need.

### SUMMARY OF THE INVENTION

The invention provides adhesive or sealant compositions that may be pre-applied to a substrate and, when ready to use, reactivated. The reactivatable adhesives of the invention may advantageously be used in the manufacture of cases and cartons to be constructed (e.g. prior to packaging) and/or sealed (e.g., after packaging).

One aspect of the invention is directed to a reactivatable adhesive composition comprising an effective amount of an energy-absorbing ingredient such that upon exposure of the adhesive to short durations of radiant energy, the adhesive is activated. Radiant energy which may be used to reactive the adhesives of the invention will desirably have a peak wavelength of from about 400 nm to about 100,000 nm, more typically from about 700 nm to about 10,000 nm, preferably from about 750 nm to about 5000 nm.

The energy-absorbing ingredient selected for use may be dissolved and/or dispersed within the adhesive composition. Pigments and organic dyes and are particularly useful energy-absorbing ingredients for use in the practice of the invention. Near infrared absorbing dyes and pigments are particularly preferred for use in the practice of the invention, but the invention is not limited thereto.

Reactivatable adhesives encompassed by the invention include but are not limited to hot melt adhesives, waterborne adhesives, solvent borne adhesives, moisture curable adhesives, ultraviolet curable adhesives, blocked urethane systems, epoxy based adhesives, and adhesives comprising an encapsulated cureative or the like.

Another aspect of the invention is directed to a reactivatable adhesive that has been applied to at least a portion of a first substrate and allowed to solidify. Upon reactivation, the adhesive melts to the extent that it is capable of bonding the first substrate to a second substrate when the second substrate is brought in contact with the adhesive present on the first substrate. In one embodiment, the adhesive is reactivated upon exposure to radiant energy.

Yet another aspect of the invention is directed to a process for bonding at least a first substrate to at least a second substrate, wherein at least a portion of at least one of said substrates has applied thereon a reactivatable adhesive. In one embodiment, the adhesive comprises an energy-absorbing ingredient and the method comprises irradiating the applied adhesive with radiant energy for a time sufficient to melt the adhesive, bringing one of said substrates in contact with the melted adhesive on the other substrate, and allowing the adhesive to solidify thereby bonding the first substrate to the second substrate.

Still another aspect of the invention is directed to articles of manufacture comprising a reactivatable adhesive. Articles encompassed by the invention include, but are not limited to, containers such as cases, cartons, boxes, trays, bags, envelops, and the like, labels electronic materials, cores and tubes, books, nonwoven absorbent articles such as diapers, sanitary hygiene products and the like. Reactivatable adhesives of the invention are particularly well-suited for use in case and carton manufacture and sealing of packaged articles. Packaged articles include consumer goods such as food and beverages, pharmaceuticals, cosmetics, breakfast cereals, beverage containers (e.g., beer bottles and the like), bakery items, dry foods (e.g., dog food), produce, household products, paper products, soaps and detergents, candy, wet food, frozen food, diapers and the like, and hard goods such as but not limited to tools, fasteners, automotive parts, and light bulbs.

Another aspect of the invention is directed to a method of closing a container having applied on at least one surface substrate thereof the reactivatable adhesive comprising an energy absorbing ingredient. The method comprises exposing the reactivatable adhesive to radiant energy for a time sufficient to melt said adhesive, bringing a second surface substrate in contact with the reactivated adhesive on the first surface substrate and, optionally, applying pressure to effect said closing. In the practice of the invention, exposure to radiant energy is typically for periods of less that about 10, more preferably less than about 5 seconds, even more preferable less than about 3 seconds. Pressure is typically applied for periods of less than about 30 seconds.

In a further aspect of the invention is directed to a method of closing a container having applied on at least one surface substrate thereof a reactivatable adhesive. In one embodiment the adhesive comprises an energy absorbing ingredient. The method comprises exposing the reactivatable adhesive to radiant energy for a time sufficient to melt said adhesive, bringing a second surface substrate in contact with the reactivated adhesive on the first surface substrate and, optionally, applying pressure to effect said closing. In the practice of the invention, exposure to radiant energy is typically for periods of less that about 10 seconds. Pressure is typically applied for periods of less than about 30 seconds.

### DETAILED DESCRIPTION OF THE INVENTION

It has now been discovered that certain adhesive characteristics, e.g., the absorption, reflection and/or transmission characteristics of a thermoplastic, can be tailored so as to optimize the materials re-activation and subsequent bond formation. The current invention provides reactivatable compositions and means by which an applied adhesive can be reactivated in an efficient manner.

Reactivation, as this term is used herein, refers to an adhesive that resides on at least a portion of at least one substrate to be bonded. A reactivatable hot melt adhesive is one that has been applied to a substrate in the molten state and allowed to cool, i.e., solidify, thereon. The solidified adhesive present on the substrate is thereafter exposed to a reactivation means whereby the adhesive is reactivated or heated to a molten state, brought in contact with a second substrate and allowed to cool or solidify, thereby bonding the two substrate together. The application of the adhesive onto a substrate for later activation or “reactivation” is referred to herein, and in the art as a “pre-applied” adhesive. The adhesive present on the substrate may be reactivated anytime after initial application to the substrate for bonding to a second substrate. The reactivation means preferable acts to preferentially heat the adhesive present on the substrate without substantially increasing the temperature of the substrate surface.

Preferred adhesive compositions of the invention contain an energy absorbing ingredient that increases the absorption and reduces the transmission of radiant energy that creates a temperature distribution within the adhesive that optimizes performance. The adhesives have improved re-activation and performance properties after irradiation. The adhesives of the invention reactivate on exposure to short durations of radiant energy and provide superior on-line performance and set speed that allows for quicker production speeds.

The improved re-activation and performance may preferable be achieved by incorporating into an adhesive an energy-absorbing ingredient. Energy-absorbing ingredients include those dyes, pigments, fillers, polymers and resins or other ingredients that are capable of absorbing energy and provide an optimal balance of absorption, reflection, transmission and conduction.

It has been discovered that when a suitable energy-absorbing ingredient is added to a conventional adhesive, reactivation upon short duration of radiant energy can be achieved. Energy-absorbing ingredients contemplated for use in the practice of the invention are commercially available and include, but are not limited to dyes, pigments and fillers. Examples include carbon black, graphite, Solvent Red (2′,3-dimethyl-4-(2-hydroxy-naphthylazo)azo-benzene), Solvent Green, dyes such as Forest Green and Royal Blue masterbatch dye available from Clariant, cyanine-based dyes, oxides such as such as titanium dioxide, and metals such as antimony, tetrakis)dialkylaminophenyl)aminium dyes, cyanine dyes, squarylium dyes and the like.

Pigments, such as carbon black and graphite, are particulate in nature and will usually have somewhat of a spherical shape with average particle sizes in the range of about 0.01 to about 7 microns. Pigment particles aggregate, so aggregate size will be larger. The pigment aggregate size in hot melt adhesives will preferably be smaller than about 500 microns. Aggregate sizes of less than about 100 microns are preferred, more preferably smaller than about 50 microns.

A wide variety of organic NIR triggers are described in the literature and are available for use in the practice of the invention. Such compounds include cyanine, metal complexes, quinone, azo, radical multiphenylmethane, perylene, aromatic annulenes, fluorenylium. Such triggers possess various absorption characteristics. For example, halogen substituted 1,4,5,8-tetraanilioanthraquinones have excellent transmittance in the vicinity of 860 nm and can absorb NIR in other ranges. Another example is squaraine, which is characterized by intense narrow absorption bands at relatively long wavelength. Also specifically designed phthalocyanine compounds have been demonstrated exhibiting high transmittance to visible light and offering high efficient cut of near infrared.

Preferred energy-absorbing ingredients for use in the practice of the invention are broad band near IR absorbers such as Epolight 1125 (Epolene, Inc), SDA6248 (H. W. Sands Corp.), SDA2072 (H. W. Sands Corp.) and carbon black. Carbon black can be purchased from Cabot under trade name of Monarch, Regal, Black Pearl, and Elftex, or Degussa (FW series), or from Columbian Chemical Company (Raven Series). Carbon black can be manufactured by different methods such as the furnace black method, the gas (channel) black method, and the lamp black method. The key parameters affecting the radian energy absorption of carbon black prepared by these various methods are average primary particle size, surface chemistry and aggregate structure.

Energy absorbing ingredients for use in the practice of the invention will typically have an absorption in the range of from about 400 nm to about 100,000 nM, more preferably from about 700 nm to about 10,000 nm, even more preferably from about 750 nm to about 5000 nm.

Suitable energy-absorbing ingredients for use in reactivatable adhesives of the invention may be identified by blending a desired adhesive with a chosen additive of various particle size and various amounts. Any conventional method of blending the energy-absorbing ingredient with the adhesive such as through use a paddle mixer or high shear mixer such as Ross ME-100LC extruder, as would be apparent to the skilled practitioner, may be used to prepare the adhesive compositions of the invention. The starting adhesive and the adhesive containing the energy-absorbing ingredient then are compared by heating samples of each with a light from a radiant heat source. The samples are tested for reactivation efficiency and bonding performance, as described in detailed in the Examples. Reactivation efficiency is the ability the adhesive to become molten in a short period of time. Suitable additives are those that reactivate quickly and exhibit acceptable bond strength. Preferred are thermoplastic adhesives which, when pre-applied to a substrate, re-activates with a short duration of exposure to radiant energy, preferably less that about 10 seconds, more preferably less than about 5 seconds, even more preferably less than about 3 seconds, and provides acceptable bond force after a short period of compression or cooling, preferably a period of less that about 30 seconds, more preferably less than about 15 seconds.

Included in the practice of the invention are adhesives comprising absorber coated fillers and encapsulated absorbers. For example, the adhesive may comprise a cureative encapsulated within a shell comprising a NIR absorbing agent. Exposure to NIR energy melts the capsule thereby expelling the curing agent and allowing for cure of the adhesive.

Radiant energy can be supplied by a number of sources, as will be apparent to the skilled practioner. Examples include lasers, a high pressure xenon arc lamp, a coiled tungsten wire, ceramic radiant heater and tungsten-halogen lamps. Preferred for use is radiant energy within the near infra-red (NIR) region. Both lamps and lasers are effective sources of NIR energy.

Peak wavelengths of from 400 nm to about 100,000 nm may be used. More typically, wavelengths of from 700 nm to about 10,000 nm, most typically from about 750 nm to about 5000 nm will be used in the practice of the invention. Commercial sources of equipment capably of generating radiant heat required for use in the practice of the invention include Research Inc. (Eden Prairie, Minn.), Chromalox (Ogden, Utah), DRI (Clearwater, Fla.), Advent Electric Inc. (Bridgeport, Pa.), and Glo-Quartz Inc. (Mentor, Ohio).

While traditional adhesives are primarily transparent to NIR, adhesives of the invention that contain a NIR absorbing ingredient absorb and reflect the energy. This allows for quicker reactivation, while hindering the energy from impinging on the substrate surface thereby creating a weak thermal boundary layer and extending the set time.

The adhesive formulations of the invention may be pre-applied in a continuous or discontinuous, e.g., as evenly spaced beads or dots, manner depending on surface area and coating weight desired. Particular patterns may be used to optimize substrate/adhesive contact. Depending on the adhesive, the bead size, thickness, distance apart and pattern will vary. The adhesive may be pre-applied to the substrate by any method known in the art, and include, without limitation roll coating, painting, dry-brushing, dip coating spraying, slot-coating, swirl spraying, printing (e.g., ink jet printing), flexographic, extrusion, atomized spraying, gravure (pattern wheel transfer) electrostatic, vapor deposition, fiberization and/or screen printing. The method of pre-application to the substrate is not critical to the practice of the invention.

The reactivation efficiency, i.e., the ability of the adhesive to become molten in a short period of time will depend on the power of the energy source (e.g., lamp or laser), the distance of the energy source from the adhesive, the number of energy sources and the like as will be apparent based on the disclosure herein. Reactivation time depends on receptivity of the adhesive, which depends on the coating weight or thickness of the adhesive and the energy flux density that the radiant source can supply to the adhesive (e.g., intensity per unit area). Energy flux density refers to the distance, focal point, power and intensity of the lamp or power source.

Preferably, the reactivatable adhesives are formulated to reactivate to a temperature of at least about 200° F., more preferably to a temperature of at least about 250° F. upon exposure of less than about 1200 watts/sq inch of near infrared energy for a period of less that about 10 seconds, more preferably less than about 5 seconds, even more preferably less than about 3 seconds.

The type of adhesive that can be reactivated in accordance with the invention is not particularly limiting or critical to the practice of the invention. Reactivatable adhesives encompassed by the invention include but are not limited to hot melt adhesives, waterborne adhesives, solvent borne adhesives, moisture curable adhesives, acrylics, silicones, ultraviolet curable adhesives, blocked urethane systems, epoxy based adhesives, and adhesives comprising an encapsulated cureative or the like. Thermoplastic and hot melt adhesives are particularly useful when formulated for pre-application and subsequent later reactivation. It will be apparent that a thermoplastic adhesive present on a substrate may be applied to a substrate in the form of a waterborne emulsion or solution.

The adhesive compositions may be used for the bonding of paper, metal, plastics, wood, and combinations thereof. Adhesive may be coated to either or both surfaces of a substrate to be bonded. If the substrate is transparent or translucent to the energy used for reactivation, the adhesive formula may be sandwiched between substrates first, and then NIR energy can be applied to initiate cure.

Any conventional polymers suitable for use in formulating adhesives, as are well known to those skilled in the art, may be used in the practice of the invention. Typical thermoplastic adhesive formulations to which an energy absorbing additive may be added in accordance with the invention comprise a wax or diluent, a thermoplastic polymer and a tackifer. In all cases, the adhesive may be formulated with tackifying resins, plasticizers, waxes and/or other conventional additives such as antioxidants and stabilizers in varying amounts as are known to those skilled in the art and as required for particular formulations. Hot melt adhesives may be prepared using techniques known in the art. Typically, the adhesive compositions are prepared by blending the components in the melt at a temperature of about 100° to 200° C. until a homogeneous blend is obtained, usually about two hours. Various methods of blending are known and any method that produces a homogeneous blend is satisfactory. Compositions of other types of adhesive formulations (e.g., waterborne formulation) and methods of preparation thereof would be apparent to the skilled practitioner.

The energy-absorbing ingredient may be added, with stirring, any time during the preparation of the base adhesive, or following preparation of the base adhesive. The amount added will depend on the type of additive the size and the dissolution or dispersion properties. The additive is added in an amount effective to reactivate (melt) the adhesive upon exposure to short durations (typically less that 10 seconds) of radiant energy. Typically, the additive will be present in an amount of about 0.001 to about 10 parts per 100 parts of the adhesive composition.

The adhesive is applied to a substrate while in its molten state and cooled to harden the adhesive layer. The adhesive product can be applied to a substrate such as a paperboard or cardboard substrate, plastic substrate, a nonwoven substrate, etc, by a variety of methods including coating or spraying in an amount sufficient to cause the article to adhere to another substrate upon reactivation.

The adhesives of the invention find use in packaging, converting, bookbinding, bag ending and in the nonwovens markets. Articles of manufacture encompassed by the invention include, but are not limited to, containers such as cases, cartons, boxes, trays, bags, envelops, and the like, labels electronic materials, cores and tubes, books, nonwoven absorbent articles such as diapers, sanitary hygiene products and the like. Reactivatable adhesives of the invention are particularly well-suited for use in case and carton manufacture and sealing of packaged articles. Packaged articles include pharmaceuticals, cosmetics, breakfast cereals, beverage containers (e.g., beer bottles and the like), bakery items, dry foods (e.g., dog food), produce, household products, paper products, soaps and detergents, candy, wet food, frozen food and the like.

The adhesives find particular use in case, carton, and tray forming, and as sealing adhesives. While the adhesives of the invention may be used, if desired, in heat seal applications, the adhesives are designed for reactivation in the absence of intense heat and pressure. Thus, the packaging manufacturer (converter) can apply an adhesive containing an energy absorbing ingredient to predetermined locations of, e.g., a carton blank. The adhesive present at one predetermined location can be reactivated by conventional heat seal means to prepare, e.g., the manufacture's joint or side seam, while the adhesive at other predetermined locations can be reactivated (e.g., with a NIR lamp or laser) in accordance with the invention to close, e.g., the end flaps following insertion of an item to be packaged.

A particularly preferred use of the adhesives of the invention are for pre-application to containers to be used for packaging wherein the pre-applied adhesive is used to form the container and/or to seal the article to be packaged within the container. Examples include various types of packages such as Bliss box packaging, clam shell type enclosures, tubs, bags, trays, bliss containers, tubular shipping containers, wrap around containers, etc. These packaging products are designed to house a variety of consumer goods, for example, hamburgers, cereals, crackers and beer bottles, etc.

The substrates to be bonded include virgin and recycled kraft, high and low density kraft, chipboard and various types of treated and coated kraft and chipboard. Also included are materials such as polyethylene, mylar, polypropylene, polyvinylidene chloride, ethylene vinyl acetate, metalized composites and various other types of films. Composite materials are also used for packaging applications such as for the packaging of alcoholic beverages. These composite materials may include chipboard laminated to an aluminum foil which is further laminated to film materials, e.g., polyethylene, mylar, polypropylene, polyvinylidene chloride, ethylene vinyl acetate and the like. Additionally, these film materials also may be bonded directly to chipboard or kraft. The aforementioned substrates by no means represent an exhaustive list, as a tremendous variety of substrates, especially composite materials, find utility in the packaging industry.

The invention is further illustrated by the following non-limiting examples.

### EXAMPLES

### Examples 1-4

Various reactivatable hot melt adhesive formulations are described in Examples 1-4. Reactivation efficiency and bonding performance of the hot melt adhesives were determined as follows:

Near Infrared (NIR) Reactivation Test

Adhesives were cast into films of 2 inch long, 1 inch wide, and 2 mm thick. The film was placed underneath a halogen tungsten lamp (250 W/120 V) of 35 mm long. The lamp was located in an aluminum reflector and the distance between the lamp filament and the adhesive top surface was kept constant (24.5 mm). The input voltage of the lamp was precisely controlled so that the power of the lamp was 140 W. The adhesive film was heated by the lamp for 20 seconds and the surface temperature of the adhesive film was continuously measured using an infrared thermal probe. The surface temperature (temperature after 20 second irradiation, beginning temperature of 70° F.) reported in the tables below are the average of six samples tested for each formulation.

Bond Strength Test

Adhesives in a bead shape were pre-coated on corrugated paperboard at the coating weight of 1.5 g/m. The bead cross-section had a dimension of 2 mm×2 mm. The pre-applied adhesive beads were cooled down to room temperature and then were subjected to NIR radiation for various periods of time. NIR radiant energy was emitted by a 240 W halogen tungsten lamp, which was placed in an aluminum reflector. The distance of the lamp filament and the adhesive bead was precisely controlled as 10.5 mm. After being radiated, the adhesive bead was exposed to air for 3.5 seconds and then another corrugated substrate (2″×2″) was placed on the top of the adhesive bead to form a bond. The bond was pressed at 1 kgf/cm² for a certain period of time and then was pulled apart. The resulting bond force, adhesive bead flatness, and the percentage of fiber tear were recorded. The bead flatness measured the deform-ability and flow-ability (i.e., the level of reactivation) of the hot melt adhesive under the test condition.

### Example 1

This example illustrates the influence of the concentration of the energy-absorbing ingredient on the reactivation efficiency and bonding performance.

A sample (Sample A) of an EVA, paraffin wax, and hydrocarbon tackifier based hot melt adhesive available from National Starch & Chemical Company (Cool-Lok® 34-2125) was compared to adhesive samples (Samples B-F) to which various amounts of carbon black (Regal 400, Cabot) had been added. Samples B-E were prepared by fully blending the adhesive and Regal 400 using a paddle mixer and all Samples had the same level of dispersion quality. The increase in adhesive temperature that occurred during the NIR reactivation test (described above) was determined and is reported in Table 1. In the Bond Strength Test, the adhesive bead was radiated for 0.3 seconds, and the bond was pressed for 15 seconds. Results (bond force, % bead flatness and % fiber tear) are reported in Table 1.

TABLE 1

| | Sample A | Sample B | Sample C | Sample D | Sample E | Sample F |
|---|---|---|---|---|---|---|
| Additive Regal 400 | 0 | 0.1 | 0.3 | 0.5 | 0.75 | 1.5 |
| Concentration (wt %) | | | | | | |
| Radiation Time (S) | 0.3 | 0.3 | 0.3 | 0.3 | 0.3 | 0.3 |
| Compression Time (S) | 15 | 15 | 15 | 15 | 15 | 15 |
| Adhesive Surface | 125 | 200 | 250 | 282 | 293 | 306 |
| Temperature (° F.) | | | | | | |
| Bond Strength (KgF) | <1 | 2-4 | >6 | >5 | 2-4 | <1 |
| Bead Flatness (%) | 0 | 50 | 100 | 100 | 25 | 25 |
| Fiber Tear (%) | 0 | 1-25 | 75-100 | 50-75 | 1-25 | 1-25 |

The results indicate that the adhesive surface temperature increased monotonically with the additive concentration increasing from 0 wt % to 1.5 wt %. However the bonding performance, such as bond strength, bead flatness, and fiber tear, showed a peak value at the additive concentration in the range from 0.3 to 0.5 wt %.

### Example 2

Additional pigments or solid particulates useful in the practice of the invention and the influence of the pigment type and concentration on the reactivation efficiency of Cool-Lok® 34-2125 are illustrated in this example. Monarch 1400 is a carbon black available from Cabot, Monarch 4750 is a carbon black available from Cabot, Printex is a carbon black available from Degussa, the graphite (particle size 1-2 microns) was obtained from Aldrich. Disperbyk is a dispersing agent available from Bykchemie. The samples were prepared by fully blending the adhesive and energy-absorbing ingredient with a mixer. Results are reported in Table 2.

TABLE 2

| | Sample G | Sample H | Sample I | Sample J |
|---|---|---|---|---|
| Monarch 1400 (wt %) | 0.5 | | | |
| Monarch 4750 (wt %) | | 0.5 | | |
| Printex L6 (wt %) | | | 1 | |
| Graphite (wt %) | | | | 1 |
| Disperbyk 108 (wt %) | 0.5 | 0.5 | | |
| Mixer | High Shear | High | Paddle | Paddle |
| | Mixer | Shear | Mixer | Mixer |
| | | Mixer | | |
| Radiation time (S) | 0.3 | 0.3 | 0.7 | 0.7 |
| Compression | 15 | 15 | 15 | 15 |
| Time (wt %) | | | | |
| Surface Temperature | 270 | 300 | 286 | 286 |
| (° F.) | | | | |
| Bond Strength (KgF) | >6 | >6 | >6 | >6 |
| Bead Flatness (%) | 100 | 100 | 100 | 100 |
| Fiber Tear (%) | 100 | 75-100 | 75-100 | 75-100 |

Samples G and H composed of finely dispersed nano-scale particles (agglomerate sizes <10 microns) contained relatively low concentrations of pigment to achieve efficient reactivation and bond strength. Samples I and J required greater concentrations due to their different particle sizes (1-2 micron) and dispersion quality. Results from these examples demonstrated that a variety of materials could be used within the scope of this invention, with performance tailored dependently on the particle size, type, radiation time, dispersion quality, and additive concentrations.

### Example 3

This example illustrates the utility of various NIR absorbing dyes as the energy-absorbing ingredient in providing short reactivation time and high bond strength. These dyes were dissolved homogeneously into the base hot melt adhesive (Cool-Lok 34-2125) and absorbed impinging radiant energy, most preferably ranging from 400 nm to 5000 nm in wavelength. Epolight 1125 is a green dye available from Epolight, near IR-1050 and near IR-1048 are dyes available from Aldrich, Inc. The samples were prepared by uniformly blending the adhesive and dye with a paddle mixer. The influence of NIR absorbing dyes on reactivation efficiency is shown in Table 3.

TABLE 3

| | Sample K | Sample L | Sample M |
|---|---|---|---|
| Epolight 1125 (wt %) | 0.5 | | |
| near IR-1050 (wt %) | | 0.5 | |
| near IR-1048 (wt %) | | | 0.5 |
| Radiation Time (S) | 0.3 | 0.3 | 0.3 |
| Compression Time (S) | 15 | 15 | 15 |
| Surface Temperature (° F.) | 245 | 245 | 241 |
| Bond Strength (KgF) | >6 | >6 | >6 |
| Bead Flatness | 100 | 100 | 100 |
| Fiber Tear | 100 | 75-100 | 75-100 |

### Example 4

The influence of different base adhesive chemistries on the required compression time is illustrated in this example. Sample N (comprising EVA, paraffin wax, and hydrocarbon tackifier based hot melt adhesive available from National Starch & Chemical Company (Cool-Lok® 34-2125)) was compared to Sample O (comprising an EnBA, paraffin wax, hydrocarbon based hot melt adhesive available from National Starch & Chemical Company (34-2100)) and Sample P (comprising a hot melt adhesive based on EVA, tackifier and wax available from National Starch & Chemical Company (34-100A)). The samples were prepared by fully blending the adhesive and carbon black (Monarch 4750, Cabot) with a high shear mixer. Good dispersion quality was obtained (agglomerate sizes <10 microns). The results are summarized in Table 4.

TABLE 4

| | Sample N | Sample O | Sample P |
|---|---|---|---|
| Viscosity at 350° F. | 200 | 810 | 4700 |
| Viscosity at 250° F. | 1125 | 3100 | 19200 |
| Additive Monarch 4750 | 0.5 | 0.5 | 0.5 |
| Concentration (wt %) | | | |
| Disperbyk 108 (wt %) | 0.5 | 0.5 | 0.5 |
| Radiation Time (s) | 0.3 | 0.7 | 0.7 |
| Compression Time (s) | 15 | 8 | 8 |
| Surface Temperature (° F.) | 300 | 330 | 328 |
| Bond Strength (KgF) | >6 | >6 | >6 |
| Bead Flatness (%) | 100 | 100 | 100 |
| Fiber Tear (%) | 75-100 | 75-100 | 75-100 |

This example indicates that using 34-2100 or 34-100A as the base adhesive, 8 seconds of compression was required to give good bonding performance (strong bond force, high percentage of bead flatness, and full fiber tear). However when 34-2125 was employed as the base adhesive, the bonds had to be compressed for 15 seconds to give the same level of bonding performance. A short compression time might be desirable in applications where the length of the compression section was limited.

### Examples 5-13

Additional reactivatable adhesive formulations are shown in Examples 5-13. In the following examples, surfaces to be bonded were free from dirt, oil and grease. These adhesive compositions may advantageously be used for the bonding of metal, plastics, wood, and combinations thereof. The adhesive of Example 10 is particularly useful as an adhesive for vinyl laminating. Adhesive may be coated to either or both surfaces of a substrate to be bonded. For near IR transparent or translucent substrates, the adhesive formula may be sandwiched between substrates first, and then NIR energy can be applied to initiate cure.

### Example 5

A single component heat cured epoxy adhesive having the composition show in Table 5 was prepared by blending EPON™ Resin 828 (available from National Starch and Chemical Co., Carbon Black, and Dicyandiamide (DICY) together and passing the mixture over a three-roll paint mill, two cycles. A Cowles Blender, or a high-speed rotor stator may also be used. Temperature was kept a low as possible.

TABLE 5

| | Pounds | Gallons |
|---|---|---|
| EPON ™ Resin 828 | 64.13 | 6.61 |
| Carbon Black (Plack Pearls 4750, Cabot) | 0.5 | 0.03 |
| Dicyandiamide (DICY) | 3.83 | 0.64 |
| Total: | 68.46 | 7.28 |

Cure was initiated by exposure to a NIR energy source for a time sufficient to achieve complete melt of DICY cureative, after which the substrates are quickly mated together. A handling bond developed within several hours, and full cure was reached at 7 days ambient.

### Example 6

A single component fast cured epoxy adhesive having the composition shown in Table 6 was prepared by blending EPON™ Resin 828, Carbon Black, and Dicyandiamide (DICY) together and passing the mixture over a three-roll paint mill, two cycles. A Cowles Blender, or a high-speed rotor stator may also be used. The temperature was kept as low as possible.

TABLE 6

| | Pounds | Gallons |
|---|---|---|
| EPON ™ Resin 828 | 100 | 10.31 |
| Dicyandiamide (DICY, SKW Corp.) | 10 | 0.75 |
| Bentone 27 (Rheox, Inc.) | 1.5 | 0.11 |
| Tetramethyl Ammonium Chloride (Accelerant) | 3 | 0.34 |
| Carbon Black (Plack Pearls 4750, Cabot) | 0.5 | 0.03 |
| No. 1 White Calcium Carbonate (Thompson, | 1.5 | 0.07 |
| Weinman & Co.) | | |
| Total: | 116.5 | 11.61 |

The surfaces to be bonded were free from dirt, oil and grease. Cure was initiated by exposure to a NIR energy source for a time sufficient to achieve complete melt of DICY cureative, after which the substrates are quickly mated together. A handling bond developed within several minutes, and full cure was reached at 3 days ambient.

This accelerated one-package Epoxy/DICY adhesive demonstrates that NIR reactivation can be utilized with formulations that employ a cure accelerant.

### Example 7

A single component blocked urethane hot melt adhesive composition having the composition shown in Table 7 was prepared by blending and reacting MDI and hexanediol adipate at 180° F. to a finished % NCO of 2.0%. Methyl ethyl ketoxime was then added to block the remaining free isocyanate functionality. Temperature was lowered to 160° F. and the glycerol cureative added. Carbon black was added by mixing with a Cowles Blender, or a high-speed rotor stator at 160° F. Blocked uncrosslinked urethane solidifies on cooling.

TABLE 7

| | |
|---|---|
| MDI | 10.0 |
| Hexanediol Adipate (30 OH#) | 70.0 |
| Methyl Ethyl Ketoxime | 3.3 |
| Glycerol | 1.2 |
| Carbon Black (Plack Pearls 4750, Cabot) | 0.5 |
| Total: | 85.0 |

Adhesive was coated to the surface to be bonded after warming and remelting the adhesive to a fluid at 160° F. Cure was initiated by exposure to NIR energy source to achieve deblocking of methyl ethyl ketoxime. The substrates were quickly mated together. A handling bond developed within several seconds, and full cure in several days at ambient temperature.

### Example 8

A single component blocked urethane liquid having the composition shown in Table 8 was prepared by blending and reacting MDI and polypropylene glycol at 160° F. to a finished % NCO of 2.0%. Methyl ethyl ketoxime was added to block remaining free isocyanate functionality. The glycerol cureative was added. Carbon black was added by mixing with a Cowles Blender, or a high-speed rotor stator at 160° F. Blocked uncrosslinked urethane is a stable liquid for several months at ambient temperatures.

TABLE 8

| | |
|---|---|
| MDI | 13.0 |
| Polypropylene Glycol (OH# 55) | 67.0 |
| Methyl Ethyl Ketoxime | 3.3 |
| Glycerol | 1.2 |
| Carbon Black (Plack Pearls 4750, Cabot) | 0.5 |
| Total: | 85.0 |

Adhesive was coated to substrate to be bonded after warming and remelting the adhesive to a fluid at 160° F. Cure was initiated by exposure to NIR energy source to achieve deblocking of methyl ethyl ketoxime and tacky gellation of the adhesive material. The substrates were quickly mated together. A handling bond developed within several minutes, and full cure in several days at ambient temperatures.

### Example 9

A single component urethane with a solid cureative phase having the composition shown in Table 9 was prepare by blending and reacting MDI and polypropylene glycol at 160° F. to a finished % NCO of 2.0%. Carbon black was added by mixing with a Cowles blender, or a high-speed rotor stator at 160° F. Urethane is a stable liquid for several months at ambient.

TABLE 9

| | |
|---|---|
| MDI | 13.0 |
| Polypropylene Glycol (OH# 55) | 67.0 |
| Desmodur TT | 6.6 |
| Carbon Black (Plack Pearls 4750, Cabot) | 0.5 |
| Total: | 87.1 |

Cure was initiated by exposure to NIR energy source to achieve melting of the Desmodur TT and tacky gellation of adhesive material. The substrates were quickly mated together. A handling bond developed within several minutes, and full cure in several days at ambient temperatures.

### Example 10

An EVA based waterborne emulsion having the composition shown in Table 10 was prepared by pre-dispersing carbon black in the plasticizer using a rotor-stator. The EVA emulsion and water was added using moderate speed axial paddle stirring.

TABLE 10

| | |
|---|---|
| EVA Emulsion (Dur-o-set E-200, Vinamul) | 88.0 |
| Diethylene/Dipropylene Glycol Dibenzoate | 7.5 |
| Plasticizer | |
| Water | 4.0 |
| Carbon Black (Plack Pearls 4750, Cabot) | 0.5 |
| Total: | 100 |

The adhesive was dried to the surface of a tack free film. The adhesive layer was later reactivated by exposure to a NIR energy source to achieve melting of adhesive material. The substrates were quickly mated together. A handling bond developed instantly.

This formula demonstrates that standard water based adhesive technologies can be modified with a near IR absorbing pigment to be made responsive to the near IR energy source for re-activation.

### Example 11

An EVA based waterborne emulsion having the composition shown in Table 11 was prepared by pre-dispersing the dye in the plasticizer using axial paddle stirring. Add in the EVA emulsion and water using moderate speed axial paddle stirring.

TABLE 11

| | |
|---|---|
| EVA Emulsion (Dur-o-set E-200, Vinamul) | 88.0 |
| Diethylene/Dipropylene Glycol Dibenzoate | 7.5 |
| Plasticizer | |
| Water | 4.0 |
| Water Dispersible Dye ADS850WS | 0.5 |
| (American Dye Source) | |
| Total: | 100 |

The adhesive is dried to the surface of a tack free film. The adhesive layer was later reactivated by exposure to NIR energy source to achieve melting of adhesive material. The substrates were quickly mated together. A handling bond develops instantly.

This formula demonstrates that standard water based adhesive technologies can be modified with a near IR absorbing dye to be made responsive to the near IR energy source for re-activation.

### Examples 12 and 13

A neoprene based waterborne emulsion having the composition shown in Table 12 and an acrylic based waterborne solution having the composition shown in Table 13 were prepared by pre-dispersing the dye in the plastizer and adding the emulsion and water using moderate speed axial paddle stirring.

TABLE 12
Formula

| | |
|---|---|
| Neoprene Latex 400 (Dupont Dow | 47.0 |
| Elastomers) | |
| Tall Oil Rosin Dispersion (Arizona) | 46.0 |
| Water | 6.5 |
| Carbon Black (Plack Pearls 4750, Cabot) | 0.5 |
| Total: | 100 |

TABLE 13
Formula

| | |
|---|---|
| Acrysol TT-678 (Rohm & Haas) | 35.0 |
| Modified Rosin Ester Dispersion (Arizona) | 55.0 |
| Water | 9.5 |
| Carbon Black (Plack Pearls 4750, Cabot) | 0.5 |
| Total: | 100 |

The adhesive is dried to the surface to a tack free film. The adhesive layer can be later reactivated by exposure to a NIR energy source to achieve melting of the adhesive material. The substrates were quickly mate together. A handling bond develops instantly.

These formulas further demonstrate that water based adhesive technologies can be modified with a near IR absorbing dye to be made responsive to the near IR energy source for re-activation.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A reactivatable adhesive, which adhesive comprises an effective amount of an energy-absorbing ingredient such that upon exposure of the adhesive to radiant energy having a peak wavelength of from about 400 to about 100,000 the adhesive is reactivated.

2. The adhesive of claim 1 wherein said reactivatable adhesive reactivates upon exposure to radiant energy having peak wavelength of from about 700 nm to about 10,000 nm.

3. The adhesive of claim 2 wherein said reactivatable adhesive reactivates upon exposure to radiant energy having peak wavelength of from about 700 nm to about 10,000 nm.

4. The adhesive of claim 1 which reactivates to a temperature of at least about 200° F. upon exposure of less than about 1200 watts/sq inch of near infrared energy for a period of less that about 10 seconds

5. The adhesive of claim 1 wherein the energy-absorbing ingredient comprises an organic dye.

6. The adhesive of claim 1 wherein the energy-absorbing ingredient comprises a pigment.

7. The adhesive of claim 6 wherein the pigment is carbon black.

8. The adhesive of claim 6 wherein the pigment is graphite.

9. The adhesive of claim 1 which is a hot melt adhesive.

10. The adhesive of claim 1 which is thermoplastic.

11. A substrate comprising the reactivatable adhesive of claim 1.

12. The substrate of claim 11 wherein the adhesive is applied to at least one predetermined location of the substrate by roll coating, painting, dry-brushing, dip coating spraying, slot-coating, swirl spraying, printing, flexographic, extrusion, atomized spraying, fiberization, gravure, electrostatic, vapor deposition and/or screen printing.

13. The substrate of claim 11 wherein the adhesive is applied as a discontinuous coating.

14. The substrate of claim 11 wherein the adhesive is applied as a continuous coating.

15. The substrate of claim 11 which is a paperboard substrate, a metal substrate, a wood substrate, a plastic substrate or a combination thereof.

16. The substrate of claim 15 which a plastic laminate.

17. The substrate of claim 11 wherein the adhesive is applied as a waterborne adhesive.

18. The substrate of claim 9 wherein the adhesive is a reactivatable hot melt adhesive.

19. The substrate of claim 1 wherein exposure to said radiant energy source initiates cure of the reactivatable adhesive.
